(19) United States
(12) Patent Application Publication
(10) Pub. No.: US 2019/0114324 A1
(43) Pub. Date: Apr. 18, 2019

(54) METHOD TO REDUCE INDEX WRITE-AMPLIFICATION

(71) Applicant: EMC IP Holding Company LLC, Hopkinton, MA (US)

(72) Inventors: Alexander John Horton Conway, Jersey City, NJ (US); Martin Losada Farach-Colton, New York, NY (US); Philip Shilane, Newtown, PA (US)

(21) Appl. No.: 16/158,136

(22) Filed: Oct. 11, 2018

Related U.S. Application Data
(60) Provisional application No. 62/571,584, filed on Oct. 12, 2017.

(51) Int. Cl. G06F 17/30

(52) U.S. Cl. CPC G06F 17/3033; G06F 17/30949

(57) ABSTRACT

One example method includes receiving a hash, inserting the hash into an array of an on-disk hash table that has one or more levels that each include a bundle of one or more arrays, and each of the arrays includes a plurality of hashes, and when the array into which the hash was inserted is full, merging the full array down to the next lower level of the on-disk hash table by appending the full array to a group of one or more arrays residing at the next lower level.

### RELATED APPLICATIONS

This application hereby claims priority to U.S. Provisional Patent Application Ser. 62/571,584, entitled METHOD TO REDUCE INDEX WRITE-AMPLIFICATION, and filed Oct. 12, 2017 (the “'584 application”). All of the aforementioned applications are incorporated herein in their respective entireties by this reference.

### FIELD OF THE INVENTION

Embodiments of the present invention generally relate to disk write and query operations. More particularly, at least some embodiments of the invention relate to systems, hardware, software, computer-readable media, and methods directed to processes for striking a balance between write operation efficiency and query lookup times by reducing index write-amplification in disk operations.

### BACKGROUND

Hash tables are commonly employed to keep track of data and associated operations performed in connection with that data. In general, a conventional hash table may be implemented as an on-disk and/or in-memory dictionary structure that includes key-value pairs that map hash values, or keys, to respective data strings, or values. A key-value pair may be referred to herein simply as a ‘hash.’ Thus, as data is written or deleted, the hash table contents are updated accordingly. The hash table also supports query operations concerning the data.

In an effort to improve disk and/or memory IO performance, hash table operations, such as insertions for example, may be batched together in a memory buffer and then merged into the hash table when the buffer is full. In this way, multiple insertions are performed in a single IO, rather than being performed as individual IO processes. The latter approach may be considerably less efficient than the single IO approach in terms of time and processing resources used.

Although this batch approach to IOs has proved beneficial in certain circumstances, merging batched insertions, for example, into sorted key-value pairs already on disk has given rise to various problems, one of which is write amplification. In general, write amplification refers to the notion that, in conventional approaches, considerably more data must be written to the hash table than simply the insertions contained in the batch. More specifically, for each insertion written to the hash table, it is necessary to also copy key-value pairs already in the hash table. That is, the actual amount of information physically written is some multiple of the logical data intended to be written. As explained in the '584 application, this multiple may be as much as 100 in some cases.

Various approaches have been devised to attempt to address the write amplification problem, one example of which is a log structured merge (LSM) table configuration, in which an additional on-disk buffer is provided between the in-memory buffer and the final on-disk hash table. While the LSM approach may reduce write amplification in some instances, there remains a need for improved insertion performance and hash table configurations.

### BRIEF DESCRIPTION OF THE DRAWINGS

In order to describe the manner in which at least some of the advantages and features of the invention can be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example configuration of some embodiments of the invention.

FIGS. 2a and 2b disclose aspects of an example multi-tiered BOA hash table.

FIGS. 3a and 3b disclose aspects of another example BOA hash table.

FIG. 4 discloses aspects of an example routing filter.

FIG. 5 discloses aspects of example computer hardware employed in embodiments of the invention.

FIG. 6 a flow diagram directed to an example method for performing an IO that takes the form of an insertion.

FIG. 7 is a flow diagram directed to an example method for performing an IO that takes the form of a query.

### DETAILED DESCRIPTION OF SOME EXAMPLE EMBODIMENTS

Embodiments of the present invention generally relate to disk write and query operations, among others. More particularly, at least some embodiments of the invention relate to systems, hardware, software, computer-readable media, and methods directed to processes that, when implemented, may help to strike a balance between write operation efficiency and query lookup times by, for example, reducing index write-amplification in disk operations. Such embodiments may be especially well suited for use in connection with environments in which the key-value pairs are unsorted. As well, example embodiments may provide for particularly efficient hash table query operations.

In more detail, example embodiments of the invention implement a bundle of arrays (BOA) data structure configuration that includes a size-tiered LSM that operates in conjunction with a routing filter. The data structure comprises a BOA hash table, which may be referred to herein simply as a BOA, that appends new data to data currently in a level, so as to significantly reduce, or eliminate, write amplification. To illustrate, insertions may be batched together in blocks of size B and stored at an uppermost level, or Level 1, of the BOA. Each group of blocks defines an array.

When there is a defined number λ of full arrays at Level 1, that is, when Level 1 is full, those arrays can then be merged down into the next lower level, or Level 2, to form a new array at Level 2. Level 2, like Level 1, may include one or more arrays. In this example then, the arrays being merged down from Level 1 constitute new data, relative to the data already residing at Level 2.

As the foregoing example illustrates, each level of the data structure includes, or will at some point, a bundle of arrays, and when a level fills, the arrays of that level are merged together in a new array of the next lower level. In this way, each level comprises a bundle of arrays, where each array contains sorted data of a prior merge. Note that these arrays may also be referred to as sorted runs and, as such, each level can be considered as comprising a collection of sorted runs. This approach can be implemented for any number ‘n’ of Levels in a data structure. Moreover, because this approach employs a multiway merge, rather than a conventional successive two-way merge process, embodiments within the scope of the invention may be relatively more efficient both in terms of IOs and internal memory operations. The improved efficiency in IOs provided by example embodiments of the invention may provide for a significant reduction in write amplification.

As noted above, embodiments of the invention may also employ a routing filter for enabling fast and efficient queries of data structures such as a BOA hash table. In general, the routing filter eliminates the need to search for data in multiple different sorted arrays. Instead, the routing filter exploits the probabilistic nature of hashes to suggest possible arrays in response to a query. Because there is a low probability that the routing filter will return a false positive, but no probability of false negatives, the routing filter may contribute significantly to the speed and efficiency of queries directed to the BOA hash table by intercepting the query and suggesting possible array locations for the key corresponding to queried data.

Advantageously then, embodiments of the invention may provide various benefits and improvements relative to conventional hardware, systems and methods. To illustrate, embodiments of the invention may improve the operation of a computing system, or element of a computing system, by significantly reducing the insertion performance penalty imposed by write amplification. As well, embodiments of the invention may provide for more focused, and relatively faster, hash table query performance, such as through the use of a routing filter. As a final example, embodiments of the invention may improve on known data structures and processes that require sorted data for effective operation. In particular, embodiments of the invention are well suited for use in connection with unsorted data and, as such, may reduce or eliminate the need to sort the hash table data. That is, like an internal memory hash table, a BOA hash table does not maintain the key-value pairs in sorted order, but rather in sorted hash order. However, using a BOA hash table is fast enough that it is possible to eliminate some situations where data would otherwise need to be sorted in order to do point-wise operations quickly.

As explained herein, advantages such as those noted can be achieved with various embodiments of the invention which include, but are not limited to, data structures that implement particular arrangements, configurations, and handling of data on computer readable media, such as disks for example. Such data structures may be defined, and reside, on disks and/or on other computer readable media. Thus, as contemplated by this disclosure, some embodiments of a data structure are implemented in a physical form.

Finally, aspects of various example embodiments are disclosed in “Optimal Hashing In External Memory,” by Alex Conway, Martin Farach-Colton, and Philip Shilane, which is attached hereto as Appendix A, and incorporated herein in its entirety, and made part of this disclosure, by this reference.

A. Aspects of Example Operating Environments

The following is a discussion of aspects of example operating environments for various embodiments of the invention. This discussion is not intended to limit the scope of the invention, or the applicability of the embodiments, in any way.

In general, example embodiments may be employed in connection with any computing environment in which data storage and protection processes are performed. Such processes may include, but are not limited to, data write processes, data read processes, queries, insertions, deletes, data backup processes, data restore processes, and data deduplication processes. Any of these processes may be performed with respect to storage, disks, or memory, including with respect to hash tables residing on-disk, and in-memory.

Some particular example embodiments may be employed in connection with appliances that may communicate with a cloud datacenter, although that is not required. Yet other embodiments may be implemented in whole or in part in a cloud datacenter or other cloud computing environment. Such a cloud datacenter can implement backup, archive, restore, and/or disaster recovery, functions. Deduplication, when performed, may take place at a client, a backup server, an appliance that communicates with a client and cloud datacenter or other entity, and/or in a cloud computing environment.

Any of the devices, including clients, servers, appliances, and hosts, in the operating environment can take the form of software, physical machines, or virtual machines (VM), or any combination of these, though no particular device implementation or configuration is required for any embodiment. Similarly, data protection system components such as databases, storage servers, storage volumes, storage disks, replication services, backup servers, restore servers, backup clients, and restore clients, for example, can likewise take the form of software, physical machines or virtual machines (VM), though no particular component implementation is required for any embodiment. Where VMs are employed, a hypervisor or other virtual machine monitor (VMM) can be employed to create and control the VMs.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files, contacts, directories, sub-directories, volumes, and any group of one or more of the foregoing.

Example embodiments of the invention are applicable to any system capable of storing and handling various types of objects, in analog, digital, or other form. Although terms such as document, file, block, or object may be used by way of example, the principles of the disclosure are not limited to any particular form of representing and storing data or other information. Rather, such principles are equally applicable to any object capable of representing information.

B. Aspects of Example BOA Hash Tables

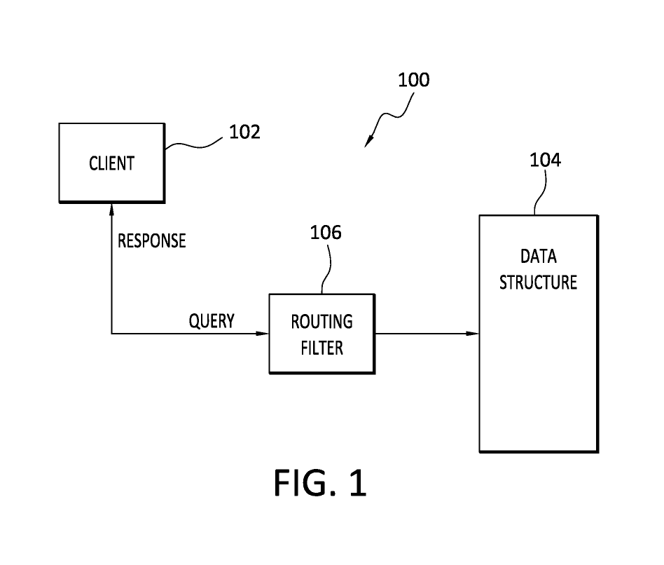

With particular attention now to FIG. 1, a high level depiction of an operating environment 100 is disclosed that may include one or more clients 102, and/or any other entities, that may perform read, write, delete, or search, operations that are directed to data that is identified in a dictionary structure such as a bundle of arrays (BOA) hash table 104. BOA hash table 104 operations, such as queries, insertions, and deletions for example, performed in connection with corresponding requests by the client may be intercepted, or otherwise processed, by a routing filter 106. In general, the routing filter 106, which may be similar to a Bloom filter, may maintain a record of which arrays of the BOA hash table 104 the various hashes are stored in. This information may be used by the routing filter 106 to identify possible hash locations in response to a query or other operation by the client 102 or other entity.

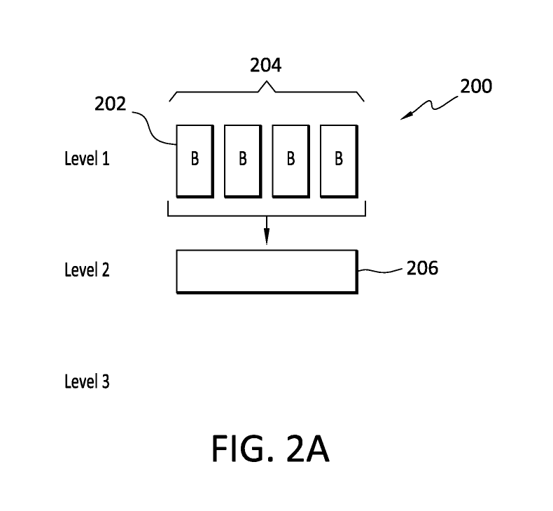

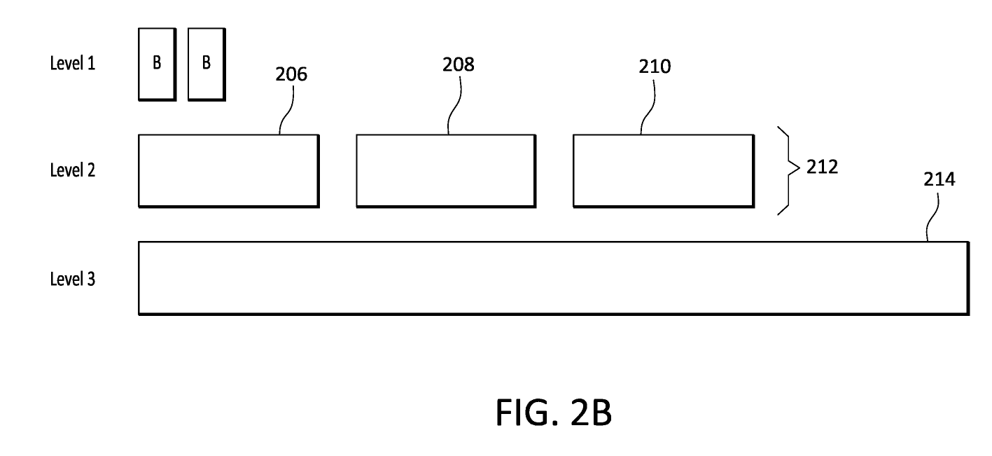

Turning now to FIGS. 2a and 2b, and with continued attention to FIG. 1, details are provided concerning an example implementation of a BOA hash table 200 in accordance with one or more embodiments of the invention. In the example of FIG. 2a, the BOA hash table, which may be an on-disk table, takes the form of a size-tiered log-structured merge (LSM) hash table and includes three levels, although any number ‘n’ of levels, and as few as two levels, may be employed in an embodiment. Operations directed to the BOA hash table 200, such as insertions for example, are batched together in blocks 202 of size B for performance in a single IO. When there are λ full arrays 204, those arrays can then be merged into a new array 206 in the next lower level, Level 2 in the example of FIG. 2a.

As shown in FIG. 2b, the structures and operations described in connection with FIG. 2a may produce a leveled structure in the hash table, where each level comprises a collection of sorted runs, that is, arrays. The runs may be queried on an individual basis using a binary search. For example, a routing filter indicates which array or arrays to check in to locate a particular key. Because each array is sorted, a binary search must be performed to find the key in each array. As noted in Appendix A however, fingerprints may be employed to improve queries and avoid the need, in some instances, for a binary search. Further, and as discussed in more detail elsewhere herein, the use of a routing filter may eliminate the need to look in multiple different runs to find a particular hash.

In the illustrative example of FIG. 2b, it can be seen that the new array 206, which comprises the full array 204, now resides at Level 2 of the hash table, along with other arrays 208 and 210 already residing at Level 2. When there are a specified number of full arrays at Level 2, those arrays, such as arrays 206-210, are merged together in sorted order to form a bundle 212 which is then appended to array 214 at Level 3. In this way, new data is appended to data already existing at the next lower level. Because the new data, from Level 2 for example, is simply appended to existing data at Level 3, there is no need to perform any sorting or reordering of data when the BOA 212 is merged into a new array at Level 3. As is apparent from the example of FIG. 2b, each succeeding, or lower, layer may be relatively larger, in terms of the volume of hashes stored, than the layer(s) above it.

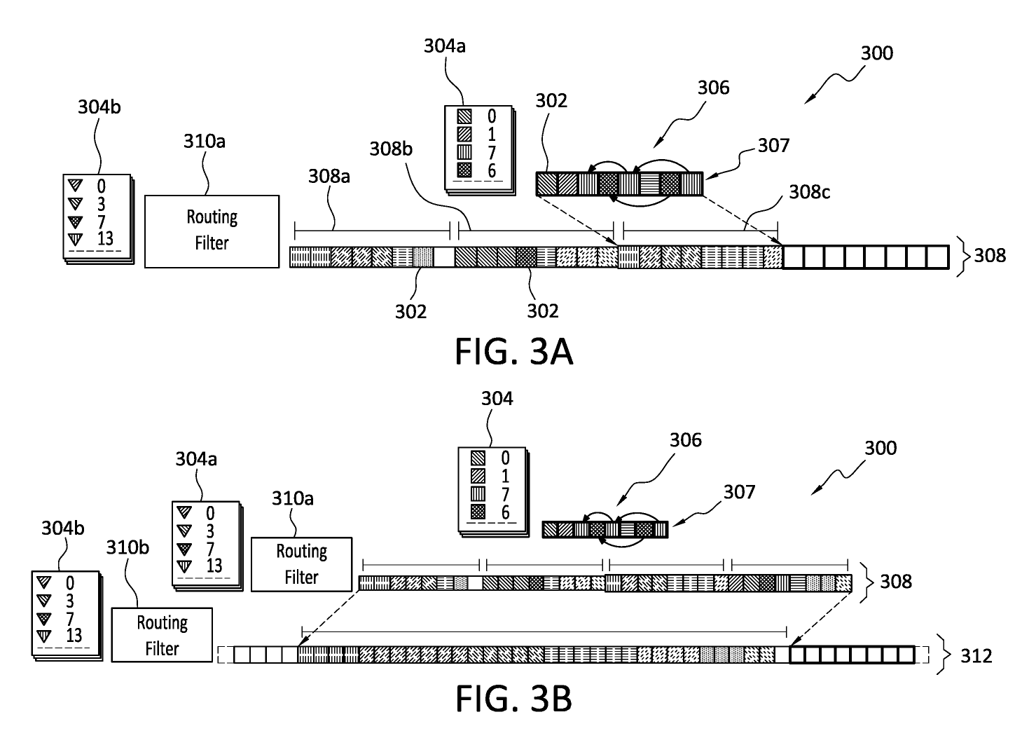

With reference now to FIGS. 3a and 3b, details are provided concerning some further implementations of a BOA configuration, denoted generally at 300. Each different shaded portion denotes a bucket, examples of which are denoted at 302, that contains a range of hash values. The start, or head, of each bucket 302 is noted in a table, such as table 304a or 304b. In general, and as indicated in FIGS. 3a and 3b, a respective table 304a and 304b may be provided for each level of a BOA. Where an array resides in an in-memory buffer, the table 304a may be an in-memory table, and where an array resides on disk, the corresponding table 304b may be an on-disk table.

In the disclosed arrangement, an in-memory buffer 306 is provided that stores a single array 307. As such, in FIG. 3a, the content of the in-memory buffer 306, once full, comprises the uppermost level of the BOA configuration 300. The BOA configuration 300 further includes a second level 308 that comprises a bundle of arrays including arrays 308a and 308b. When the array 307 is full, it is merged into the bundle of arrays residing in the second level 308, as shown in FIG. 3a, to become array 308c. More specifically, the array 307 is appended to the group of arrays 308a and 308b and, as such, the in-memory buffer 306 may now be temporarily empty, at least until new key-value pairs are written to it. After the array 307 has been appended, the tables 304a and 304b may be updated accordingly to reflect this change. In the arrangement of FIG. 3a, a routing filter 310a is also provided for the second level 308.

Turning now to FIG. 3b, another level 312 of the example BOA 300 is indicated. The level 312 is larger than, and resides below, the level 308. As shown in FIG. 3b, the second level 308 is being merged down into the level 312 and appended to the arrays already existing at the level 312. As such, the first level 308 may temporarily empty, at least until further arrays are written to it from the in-memory buffer 306.

C. Write Amplification and BOA Hash Tables

With the foregoing discussion of aspects of example BOA hash tables in view, attention is directed now to some further functional and operational aspects of such BOA hash tables. As noted elsewhere herein, the disclosed BOA hash tables may be advantageous at least insofar as they provide for a reduction in a write amplification penalty insofar as they implement a more streamlined approach to the processing of insertions. In particular, a key-value pair is grouped with other key-value pairs until an array is filled, and then the array is merged with, that is, appended to, a bundle of arrays at the next lower layer. In this way, the rest of the data at the next lower layer need not be accessed. A G-way merge implemented by embodiments of the invention contrasts, for example, with a two-way merge of two sorted arrays where one of the sorted arrays is G times larger than the other of the two sorted arrays. Multiway merges such as the G-way merge are typically more efficient than a series of successive two-way merges, both in terms of IOs and in terms of internal memory operations. This additional 10 efficiency provides the principle reduction of the write amplification penalty.

More particularly, an approach that does not employ a BOA hash table such as the disclosed BOA hash table examples would require a much less efficient process in which the entire lower layer would be read in, the insertion made into the data of the lower layer, and then the modified lower layer, including the insertion, written to disk. Thus, embodiments of the invention may, among other things, significantly reduce the extent to which write amplification is experienced in connection with insertion processes, and the other disclosed processes involving hash values.

D. Aspects of Example Routing Filters

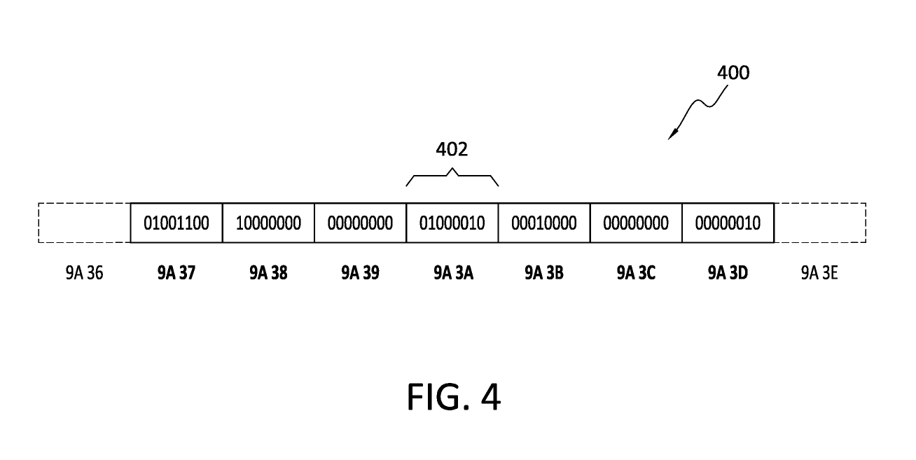

While the disclosed BOA hash tables and associated processes, including G-way merges, are effective in reducing a write amplification penalty, it may be possible in some circumstances to enhance the performance of such BOA hash tables where memory and query costs are concerned. In at least some embodiments, such performance enhancements may be achieved with the use of one or more routing filters in conjunction with a multilayered BOA hash table. Following is a discussion of aspects of routing filters, one example of which is generally denoted at 400 in FIG. 4.

In general, embodiments of a routing filter serve to eliminate the need to search all of the λ runs on a given level (see, e.g., FIG. 2b, where Level 2 has three runs) in response to a query. To this end, the routing filter may take the form of a probabilistic data structure which keeps track of which keys are stored in which array. As well, the routing filter supports sequential insertion processes, such as are employed with the BOA hash tables disclosed herein.

Turning now to FIG. 4, a portion of a routing filter 400 is disclosed. This example routing filter 400 includes one or more bundles 402, each of which comprises an 8 bit array. As indicated, the positions correspond to prefixes of the hash, and the bit array at that position indicates which arrays in the bundle contain a key with that hash prefix. Thus, a hash with the prefix 9A3A is likely to be in arrays 1 and 6 of the referenced bundle 402. Thus, when a query is received for that hash, the routing filter 400 can respond by identifying arrays 1 and 6, whose value is 1, of the bundle 402 as likely locations for the hash specified by the query. Thus, the query process need not search all bundles in all runs of the hash table but, instead, can focus on the particular bundle and arrays identified by the routing filter 400. Consequently, the query may be performed relatively quickly and efficiently, thereby reducing the memory and IO overhead relative to the overhead that would otherwise be incurred if all of the λ runs on a given level had to be searched.

E. Example Host and Server Configurations

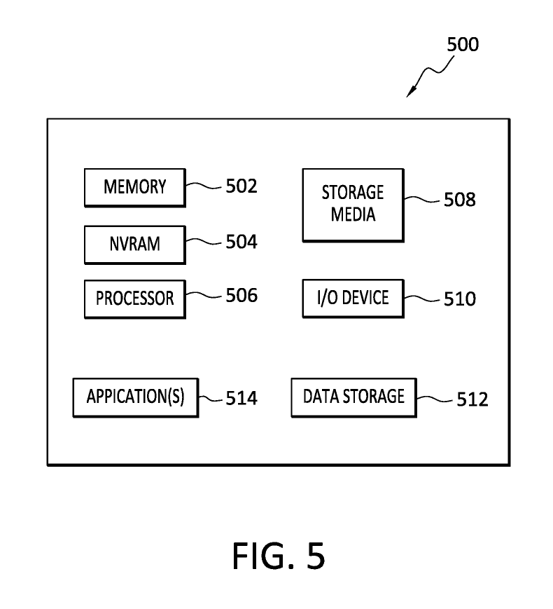

With reference briefly now to FIG. 5, any one or more of the operating environment 100, client 102, data structure 104, and routing filter 106, and any other embodiments of the aforementioned elements, can take the form of, include, reside in/on, and/or be hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may comprise one, some, or all, of random access memory (RAM), non-volatile random access memory (NVRAM) 504, read-only memory (ROM), and persistent memory, one or more hardware processors 506, non-transitory storage media 508, I/O device 510, and data storage 512. One or more of the memory components 502 of the physical computing device can take the form of solid state device (SSD) storage. As well, one or more applications 514 are provided that comprise executable instructions. Such executable instructions can take various forms including, for example, instructions executable to perform any method or portion thereof disclosed herein. Such instructions may be executable by/at any of a cloud computing site, cloud datacenter, client, restore module, appliance, backup server, restore server, or any other entity, to perform any one or more of the functions disclosed herein, including, but not limited to, data deduplication, hash table functions and operations, and routing filter functions and operations.

F. Aspects of Example Methods for IOs

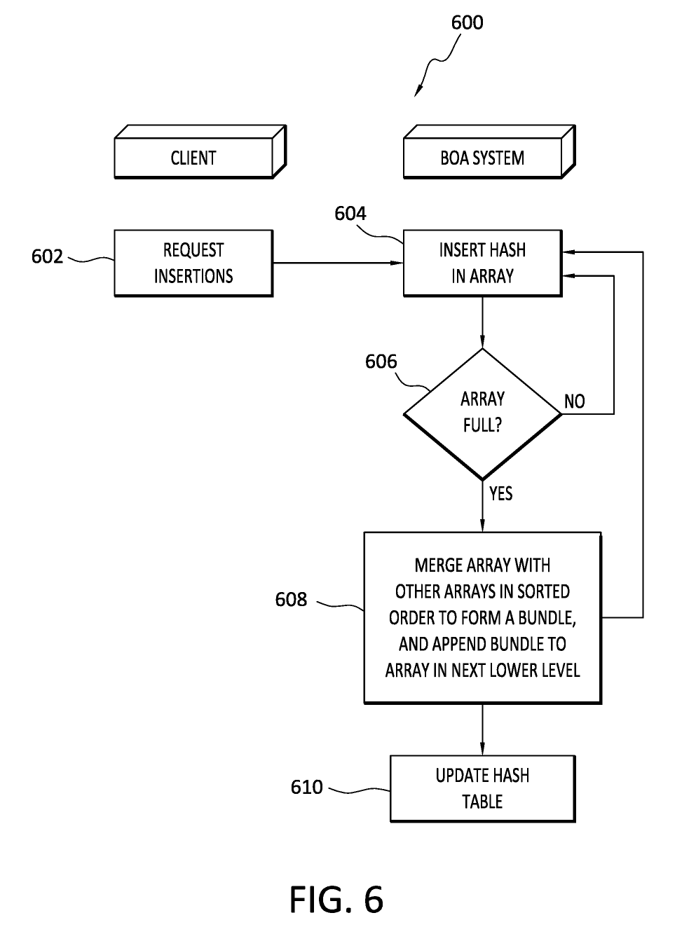

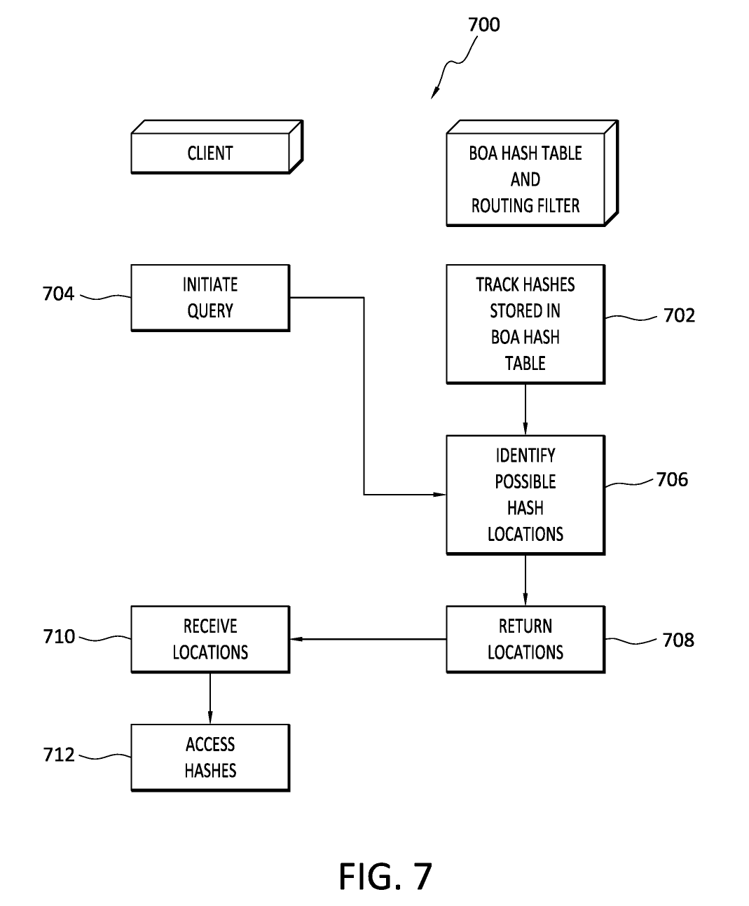

With attention now to FIGS. 6 and 7, details are provided for some example methods for performing IOs such as insertion processes and queries in connection with a BOA hash table and routing filter. One example of an insertion process is denoted generally at 600 in FIG. 6. As indicated, part or all of the insertion process 600 can be performed by/at a BOA hash table, example embodiments of which are disclosed herein. The BOA hash table may reside on-disk and operate in cooperation with a buffer, such as an in-memory buffer for example.

The process 600 can begin when a client requests an insertion 602. The insertion 602 may be implicated, for example, by a write process initiated by the client. While not specifically indicated in FIG. 6, the data requested by the client to be written may be hashed so as to generate the key-value pair that is the subject of the insertion 602. At 604, the hash is inserted in an array. As used in connection with FIG. 6, the array may refer to an array in a BOA hash table, and/or may refer to an in-memory buffer whose contents will later be merged into a layer of the BOA hash table.

Regardless of whether the insertion 604 occurs in connection with an in-memory buffer, or a layer of a BOA hash table, the method 600 may continue to iterate as long as a determination is made 606 that the array is not full. Once the array is determined 606 to be full, then the array is merged into the next lower level 608, which may be any level of a BOA hash table. This may result in the emptying, at least temporarily, of the in-memory buffer, or the layer from which the array was merged, as applicable. More specifically, the full array may be appended to a group of one or more arrays in the next lower level. After a merge has been performed whether commencing from an in-memory buffer, or a layer of the BOA hash table, the BOA hash table is then updated 610 to reflect the merger. It will be appreciated that processes 604-610 can be repeated as many times as needed, without limit. Correspondingly, an associated BOA hash table may have any number ‘n’ of successive layers, where each layer is larger than the layers above it.

Turning now to FIG. 7, details are provided for some example methods for responding to queries in connection with a system that includes a BOA hash table and routing filter. One example of process for servicing a query is denoted generally at 700 in FIG. 7. As indicated, part or all of the query response process 700 can be performed by/at a BOA hash table in cooperation with one or more routing filters, example embodiments of which are disclosed herein. The BOA hash table and routing filters may reside on-disk and operate in cooperation with a buffer, such as an in-memory buffer for example.

While not necessarily part of a query process, the hashes stored in the BOA hash table may be tracked 702 by the routing filter. As such, the routing filter is responsive to queries, such as a query 704 initiated by a client. In response to the query 704, the routing filter may identify 706 possible locations, in one or more arrays of the BOA hash table, for the hash implicated by the query. The location information may then be returned 708 to the client or other entity that initiated the query. After receipt of the location information 710, the client can then access the hashes 712 and thus the query is satisfied.

G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, or other machine may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a hash;
inserting the hash into an array of an on-disk hash table that has one or more levels that each include a bundle of one or more arrays, and each of the arrays includes a plurality of hashes; and
when the array into which the hash was inserted is full, merging the full array down to the next lower level of the on-disk hash table by appending the full array to a group of one or more arrays residing at the next lower level.

2. The method as recited in claim 1, wherein each level in the on-disk hash table stores a larger volume of hashes than any level above it.

3. The method as recited in claim 1, wherein each level in the on-disk hash level varies by a specific multiple relative to an adjacent level.

4. The method as recited in claim 1, wherein when the full array is merged, no changes are made to the group of arrays in the level into which the full array has been merged.

5. The method as recited in claim 1, wherein the on-disk hash table has at least three levels.

6. The method as recited in claim 1, further comprising updating a bit array of a routing filter to indicate the location of the inserted hash.

7. The method as recited in claim 1, wherein the hashes in each of the arrays are sorted within the respective array where they are located.

8. The method as recited in claim 1, further comprising:
receiving a query at a routing filter associated with the on-disk hash table;
using the routing filter, identifying a possible location of a hash identified by the query; and
returning the possible location of the hash.

9. The method as recited in claim 1, wherein the on-disk hash table is a log-structured hash table.

10. The method as recited in claim 1, wherein the method is performed as part of a data deduplication process.

11. A non-transitory storage medium having stored therein computer-executable instructions which, when executed by one or more hardware processors, perform the following operations:
receiving a hash;
inserting the hash into an array of an on-disk hash table that has one or more levels that each include a bundle of one or more arrays, and each of the arrays includes a plurality of hashes; and
when the array into which the hash was inserted is full, merging the full array down to the next lower level of the on-disk hash table by appending the full array to a group of one or more arrays residing at the next lower level.

12. The non-transitory storage medium as recited in claim 11, wherein each level in the on-disk hash table stores a larger volume of hashes than any level above it.

13. The non-transitory storage medium as recited in claim 11, wherein each level in the on-disk hash level varies by a specific multiple relative to an adjacent level.

14. The non-transitory storage medium as recited in claim 11, wherein when the full array is merged, no changes are made to the group of arrays in the level into which the full array has been merged.

15. The non-transitory storage medium as recited in claim 11, wherein the on-disk hash table has at least three levels.

16. The non-transitory storage medium as recited in claim 11, wherein the operations further comprise updating a bit array of a routing filter to indicate the location of the inserted hash.

17. The non-transitory storage medium as recited in claim 11, wherein the hashes in each of the arrays are sorted within the respective arrays where they are located.

18. The non-transitory storage medium as recited in claim 11, wherein the operations further comprise:
receiving a query at a routing filter associated with the on-disk hash table;
using the routing filter, identifying a possible location of a hash identified by the query; and
returning the possible location of the hash.

19. The non-transitory storage medium as recited in claim 11, wherein the on-disk hash table is a log-structured hash table.

20. The non-transitory storage medium as recited in claim 19, wherein the operations are performed as part of a data deduplication process.
